(19) United States
(12) Patent Application Publication
(10) Pub. No.: US 2024/0102215 A1
(43) Pub. Date: Mar. 28, 2024

(54) Articles and Methods for Treating a Textile with an Antimicrobial Agent

(71) Applicant: Applied Silver, Inc., Hayward, CA (US)

(72) Inventors: Priya Balachandran, Palo Alto, CA (US); Elizabeth Ann Hutt Pollard, Edmond, OK (US); Sean D. Morham, San Francisco, CA (US); Seth Donrovich, Davis, CA (US)

(21) Appl. No.: 18/264,021

(22) PCT Filed: Feb. 2, 2022
(86) PCT No.: PCT/US2022/014886

§ 371 Date: Aug. 2, 2023

Related U.S. Application Data
(60) Provisional application No. 63/144,854, filed on Feb. 2, 2021.

(51) Int. Cl. D04H 1/4291; C11D 3/48; D04H 1/4334; D04H 1/435; D06M 11/83; D06M 13/46; D06M 16/00

(52) U.S. Cl. CPC D04H 1/4291; C11D 3/48; D04H 1/4334; D04H 1/435; D06M 11/83; D06M 13/46; D06M 16/00; C11D 2111/12

(57) ABSTRACT

In one aspect, an example article for treating a textile with an antimicrobial agent includes: (a) a nonwoven multicomponent sheet, wherein the nonwoven multicomponent sheet comprises at least two materials; and (b) an antimicrobial agent comprising at least one of a metal ion or quaternary ammonium compound having antimicrobial activity, wherein an efficacious amount of at least one of the metal ion or quaternary ammonium compound transfers to the textile during a laundry cycle.

### FIELD

The disclosure relates to articles and methods for treating a textile with an antimicrobial agent.

### BACKGROUND

The microbial contamination of all type of textiles, including fabrics, curtains, linens, and clothing can contribute to staining of the textiles, unwanted odor, and the spread of disease.

Accordingly, the inventors have identified a need in the art to provide cost effective and convenient products and methods for applying antimicrobial products to textiles, particularly for products and methods for applying antimicrobial products to textiles that may be used in existing laundry equipment (washers and dryers) and detergents without the need for specialized equipment.

### SUMMARY

In one aspect, an article for treating a textile with an antimicrobial agent is disclosed. The article may be made up of a nonwoven multicomponent sheet. The multicomponent sheet may contain at least two materials.

For example, these at least two materials may include two or more of the following: polyethylene, polypropylene, polyethylene terephthalate, or polyurethane. The polyethylene may include high-density polyethylene. In some examples, the nonwoven sheet may include at least 30% high-density polyethylene and at least 30% polyethylene terephthalate. In some examples, the nonwoven sheet may include at least 30% high-density polyethylene and at least 30% polypropylene. In some examples, the nonwoven sheet may include at least 49% high-density polyethylene and at least 49% polyethylene terephthalate. In some examples, the nonwoven sheet may include at least 49% high-density polyethylene and at least 49% polypropylene. In other examples, these at least two materials may include rayon. In still other examples, the at least two materials may include rayon and polyester. In some examples, the nonwoven sheet may include at most 30% rayon and at most 70% polyester.

In another example, the nonwoven multicomponent sheet can include one portion. In another example, the nonwoven multicomponent sheet can include a first portion and a second portion, wherein the first portion can include the at least two materials and the second portion can include an additional material.

In another aspect, the nonwoven multicomponent sheet may have one or more particular dimensions. For example, the nonwoven multicomponent sheet may have one or more of the following approximate dimensions: (i) 8 inches length; (ii) 4 inches width; and (iii) 0.5 inches thickness. In another aspect, the nonwoven multicomponent sheet may have one or more of the following approximate dimensions: (i) 12.5 inches length; (ii) 8.5 inches width; and (iii) 0.015 inches thickness. These dimensions may refer to either a folder or non-folded sheet, among other possibilities.

In another aspect, the article may contain an antimicrobial agent. The antimicrobial agent may be made up of at least one of a metal ion or a quaternary ammonium compound (which may include one or more quaternary ammonium ions), either or both of which may have antimicrobial activity. The metal ion may be a silver ion or copper ion. The antimicrobial agent may also have a particular concentration of the metal ion or a quaternary ammonium compound, or both (e.g., 3000 to 5000 parts per million (“ppm”) of silver ion).

In a further aspect, the article is configured to transfer at least one of a metal ion and a quaternary ammonium compound in an efficacious amount to reduce, eliminate or prevent microbial contamination of the textile. In some examples, the efficacious amount may be between 1.5 and 15 milligrams (“mg”) of silver ion (“Ag”) per kilogram (“kg”) of textile.

In some examples, the laundry cycle may include a wash cycle and the efficacious amount of at least one of the metal ion or quaternary ammonium compound may transfer to the textile based on exposure to water during the wash cycle. In other examples, the laundry cycle may include a rinse cycle and the efficacious amount of at least one of the metal ion or quaternary ammonium compound may transfer to the textile based on exposure to water during the rinse cycle.

In other example embodiments, the laundry cycle may include a dry cycle and the efficacious amount of at least one of the metal ion or quaternary ammonium compound may transfer to the textile based on exposure to water during the dry cycle. In other examples, the laundry cycle may include a dry cycle and the efficacious amount of at least one of the metal ion or quaternary ammonium compound may transfer to the textile based on exposure to heat during the dry cycle. In other examples, the laundry cycle may include a dry cycle and the efficacious amount of at least one of the metal ion or quaternary ammonium compound may transfer to the textile based on exposure to air during the dry cycle.

In another aspect, the antimicrobial agent may be applied to the nonwoven multicomponent sheet and allowed to dry in a low-light condition (e.g., in the absence of ultraviolet (“UV”) light).

In another aspect, a method of producing an article is disclosed. The method may including producing a nonwoven multicomponent sheet treated with an antimicrobial agent. In some examples, the nonwoven multicomponent sheet comprises at least two material and applying an antimicrobial agent comprising at least one of a metal ion or quaternary ammonium compound having antimicrobial activity with the nonwoven multicomponent sheet. In a further aspect, an efficacious amount of at least one of the metal ion or quaternary ammonium compound may transfer to the textile during a laundry cycle.

In yet another aspect, a method for treating a textile is disclosed. The method may include loading the textile and the article of the disclosure into a container containing water. The method may also include exposing the textile to the article during a laundry cycle. The laundry cycle may include at least one of a wash cycle and a rinse cycle. The method may also include transferring the textile and the article to a dryer and conducting a dry cycle and/or a steam cycle.

In yet another aspect, an additional or alternative method for treating a textile is disclosed. The method may include loading the textile and the article of the disclosure into a dryer. The method may also include exposing the textile to the article during the laundry cycle. The laundry cycle may include a dry cycle.

### DESCRIPTION

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

For purposes of this disclosure, the terms “amount” and “concentration” are used interchangeably. Namely, for the purposes of this disclosure, an amount may be described in milligrams (“mg”) and concentration may be described in parts per million (“ppm”) or milligrams per kilogram (“kg” and “mg/kg”, respectively).

The disclosure is directed to an article (e.g., a sheet) made of a nonwoven multicomponent material that is treated with an antimicrobial agent and then used to transfer antimicrobial properties to a textile during a laundry cycle. This article may be put in a washing machine (e.g., in the wash basin of a residential washing machine) along with textiles to be laundered at the start of a laundry cycle, remain in the washing machine with the textiles during the wash and/or rinse cycles, and then be transferred with the textiles to a dryer and remain in the dryer with the textiles during a dry cycle, among other possibilities. During any one (or all) of these laundry cycles, the article may transfer an amount of a material having antimicrobial properties (e.g., a metal ion and/or a quaternary ammonium compound) that is sufficient to impart efficacious antimicrobial properties to the laundered textiles during the laundry cycle.

In one aspect, an article for treating a textile with an antimicrobial agent is disclosed. The article may be sheet made of multiple components or compounds or materials (i.e., a “multicomponent” sheet). The multicomponent sheet may be made up of any one or more of the following materials: polyethylene, high-density polyethylene, polypropylene, polyethylene terephthalate, polyurethane, cellulose, silicone, polyurethane, low-density polyether, polyvinyl alcohol, polyester, rayon, acetate, nylon, polyester, spandex, lyocell, flax, cotton, wool, and felt, or any combination thereof. The multicomponent sheet may be in the form of a single sheet or multiple sheets. Other examples are possible.

For example, the multicomponent sheet may also be folded and/or packaged in a number of ways. In some examples, the multicomponent sheet may be folded onto itself (e.g., in a bifold or trifold manner) to comport with the dimensions of a package in which the sheet is transported and/or to improve the retention of treatment on the sheet until the sheet is used in a particular environment, among other possibilities.

For example, these materials may also include any other materials that are capable of being loaded with a metal ion and/or quaternary ammonium compound and releasing those ions into a particular environment (e.g., a laundry cycle in a washing machine and/or dryer).

In some embodiments, these materials may be woven, nonwoven, or a combination of the two, and may be manufactured by one or more processes. In still other embodiments, the multicomponent sheet may have characteristics that may be attributable to the materials from which it is composed and/or how it is manufactured (e.g., a nonwoven multicomponent sheet).

In some examples, the multicomponent sheet may include specific combinations and/or amounts of two or more of these materials. For example, the multicomponent sheet may include: at least 30% high-density polyethylene and at least 30% polyethylene terephthalate, at least 35% high-density polyethylene and at least 35% polyethylene terephthalate, at least 40% high-density polyethylene and at least 40% polyethylene terephthalate, at least 45% high-density polyethylene and at least 45% polyethylene terephthalate, and so on. In another example, the multicomponent sheet may include at least 49% high-density polyethylene and at least 49% polyethylene terephthalate. In other examples, the multicomponent sheet may include: at least 30% high-density polyethylene and at least 30% polypropylene, at least 35% high-density polyethylene and at least 35% polypropylene, at least 40% high-density polyethylene and at least 40% polypropylene, at least 45% high-density polyethylene and at least 45% polypropylene, and so on. In another example, the multicomponent sheet may include at least 49% high-density polyethylene and at least 49% polypropylene.

In other examples, the multicomponent sheet may include a number of different materials in one or more specific combinations. In some examples, the multicomponent sheet may include material (e.g., a bi-component material) containing approximately: 49.65% high-density polyethylene, 49% high-density polyethylene, 45% high-density polyethylene, 40% high-density polyethylene, 35% high-density polyethylene, 30% high-density polyethylene, 25% high-density polyethylene, 20% high-density polyethylene, 15% high-density polyethylene, 10% high-density polyethylene, or 5% high-density polyethylene. In some examples, the multicomponent sheet may include a material (e.g., a bi-component material) containing approximately: 49.65% polyethylene terephthalate, 49% polyethylene terephthalate, 45% polyethylene terephthalate, 40% polyethylene terephthalate, 35% polyethylene terephthalate, 30% polyethylene terephthalate, 25% polyethylene terephthalate, 20% polyethylene terephthalate, 15% polyethylene terephthalate, 10% polyethylene terephthalate, or 5% polyethylene terephthalate. In some examples, the multicomponent sheet may include a material (e.g., a bi-component material) containing approximately: 0.1% titanium dioxide, 0.2% titanium dioxide, 0.3% titanium dioxide, 0.4% titanium dioxide, 0.5% titanium dioxide, 0.6% titanium dioxide, 0.7% titanium dioxide, 0.8% titanium dioxide, 0.9% titanium dioxide, 1% titanium dioxide, 2% titanium dioxide, 3% titanium dioxide, 4% titanium dioxide, or 5% titanium dioxide. In some examples, the multicomponent sheet may include a material (e.g., a bi-component material) containing approximately: 0.1% finish oil, 0.2% finish oil, 0.3% finish oil, 0.4% finish oil, 0.5% finish oil, 0.6% finish oil, 0.7% finish oil, 0.8% finish oil, 0.9% finish oil, 1% finish oil, 2% finish oil, 3% finish oil, 4% finish oil, or 5% finish oil.

In still other examples, the multicomponent sheet may include at least two materials that may be made by different processes or contain different materials, but are commonly referred to by the same name (e.g., rayon). In this regard, any of the materials disclosed herein may contain one or more subparts or compounds, in a number of different configurations.

In another aspect, the multicomponent sheet can be made up of one or more portions, any of which may be made up of one or more materials. For example, the multicomponent sheet may include a first portion made up of one or more materials and a second portion made up of one or more other materials. The first portion can include one or more materials and the second portion can include an additional material.

For example, the multicomponent sheet can include one or more layers of one or more materials. In one example, the multicomponent sheet can include a first layer of a first material and a second layer of a second material. The first material and second material can be independently selected from any of the materials as described herein, but in particular embodiments, the first material is polypropylene and the second material is polyethylene (e.g., high-density polyethylene). In other example, the multicomponent sheet can include a first layer of a first material, a second layer of a second material, and a third layer of a third material. The first material, second material, and third materials can be independently selected from any of the materials as described herein. In some embodiments, the first material, second material, and third material are all different. In other embodiments, the first material and the third material are different from the second material. In some embodiments the first material and the third material are the same and the second material is different from the first and third materials. For example, in some embodiments, the first material and third material is polypropylene and the second material is polyethylene (e.g., high-density polyethylene).

In another aspect, the multicomponent sheet may have one or more dimensions, configurations, or other physical attributes (e.g., volumes, masses, densities, etc.) that help facilitate more efficacious results during a laundry cycle.

For example, the multicomponent sheet may have dimensions that contribute to one or more efficacious results. In one example, the multicomponent sheet may have dimensions that facilitate an efficacious transfer of a metal ion or a quaternary ammonium compound during a laundry cycle. These dimensions may include those that are similar to other washer and/or dryer sheets that are commercially available or otherwise (e.g., a multicomponent sheet having approximate dimensions of (i) 8 inches length; (ii) 4 inches width, and (iii) 0.5 inches thickness or (i) 12.5 inches length; (ii) 8.5 inches width; and (iii) 0.015 inches thickness). The dimensions may be adjusted to the extent that larger or smaller sheets may accommodate more or less metal ion or quaternary ammonium compound as needed to treat a particular quantity of textiles.

The shape of the nonwoven multicomponent sheet is not particularly limited. For example, the nonwoven multicomponent sheet may be have rounded or square edges. In some example, the surface area of one side of the sheet may be in the range from about 60 in² to about 150 in² (e.g., in the range of about 70 to 150 in², 80 to 150 in², 90 to 150 in², or 60 to 130 in², or 70 to 130 in², or 80 to 130 in², or 90 to 130 in², or 60 to 120 in², or 70 to 120 in², or 80 to 120 in², or 90 to 120 in²) For example, the nonwoven multicomponent sheet may be at least 8 inches (e.g., at least 9 inches, 10 inches, 11 inches, or 12 inches) in length. In other example, the nonwoven multicomponent sheet may be at most 8 inches (e.g., at most 7 inches, 6 inches, or 5 inches) in length. For example, in some embodiments, the nonwoven multicomponent sheet may have a length in the range of 4 to 20 inches (e.g., in the range of 4 to 18 inches, or 4 to 16 inches, or 4 to 14 inches, or 4 to 12 inches, or 6 to 20 inches, or 6 to 18 inches, or 6 to 16 inches, or 6 to 14 inches, or 6 to 12 inches, or 8 to 20 inches, or 8 to 18 inches, or 8 to 16 inches, or 8 to 14 inches, or 8 to 12 inches). In some embodiments, the nonwoven multicomponent sheet may be at least 4 inches (e.g., at least 5 inches, 6 inches, 7 inches, 8 inches, or 9 inches) wide. In other embodiments, the nonwoven multicomponent sheet may be at most 4 inches (e.g., at most 3 inches, 2 inches, or 1 inch) wide. For example, the nonwoven multicomponent sheet may have a width in the range of 2 to 14 inches (e.g., in the range of or 2 to 12 inches, or 2 to 10 inches, to 2 to 8 inches, or 4 to 14 inches, or 4 to 12 inches, or 4 to 10 inches, or 4 to 8 inches, or 6 to 14 inches, or 6 to 12 inches, or 6 to 10 inches, or 6 to 8 inches). In other example, the nonwoven multicomponent sheet may be at least 0.5 inches (e.g., at least 1 inch, 1.5 inches, or 2 inches) thick. In other examples, the nonwoven multicomponent sheet may be at most 0.5 inches (e.g., at most 0.4 inches, 0.2 inches, 0.1 inches, 0.05 inches, 0.02 inches, 0.015 inches, or 0.01 inches) thick. For example, the nonwoven multicomponent sheet may have a thickness in the range of 0.01 to 2 inches (e.g., in the range of 0.01 to 1.5 inches, or 0.01 to 1 inch, or 0.01 to 0.5 inches, or 0.01 to 2 inches, or 0.01 to 1.5 inches, or 0.01 to 1 inch). In other examples, the nonwoven multicomponent sheet has a thickness in the range of approximately 0.1 to 0.5 inches (e.g., in the range of 0.1 to 0.4 inches, or 0.1 to 0.35 inches, or 0.1 to 0.3 inches, or 0.1 to 0.25 inches, or 0.1 to 0.2 inches). These dimensions may refer to a folded or non-folded sheet.

In another example, the multicomponent sheet may have configurations that contribute to one or more efficacious results. In one example, the multicomponent sheet may have configuration that facilitate an efficacious transfer of a metal ion or a quaternary ammonium compound during a laundry cycle. These configurations may include those that are similar to other washer and/or dryer sheets that are commercially available or otherwise (e.g., a multicomponent sheet that is flat, folded on itself in one or more directions, among other possibilities). In yet another aspect, the multicomponent sheet may include may one or more washer and/or dryer sheets that are commercially available (e.g., a multicomponent sheet may include an existing washer and/or dryer sheet, among other components and/or possibilities).

In another aspect, the article may contain one or more antimicrobial agents, which may be applied to the article in one or more manners. For example, the article may be sprayed with a solution of the antimicrobial agent or dipped in a solution of the antimicrobial agent. A solution or the antimicrobial agent may also be rolled onto the article.

After applying the antimicrobial agent to the article with, the article may be dried and/or otherwise cured before use in a particular environment. In one aspect, the antimicrobial agent may be applied to the multicomponent sheet and allowed to dry in a low-light condition (e.g., the absence of UV light). By doing so, the article may dry with one or more physical attributes (e.g., drying the absence of UV light may allow the article to dry without any discoloration, from the antimicrobial agent or otherwise). Other application and/or drying conditions are possible.

In an example embodiment, the antimicrobial agent may contain one or more metal ions having antimicrobial activity. In one aspect, the metal ion may be a silver ion or copper ion. The antimicrobial agent may also have a particular concentration of the metal ion. In some examples, the antimicrobial agent may contain at least: 100 parts per million (“ppm”) of silver ion, 150 ppm of silver ion, 200 ppm of silver ion, 250 ppm of silver ion, 300 ppm of silver ion, 350 ppm of silver ion, 400 ppm of silver ion, 450 ppm of silver ion, or 500 ppm of silver ion. In other examples, the antimicrobial agent contains at least 2000 parts per million (“ppm”) of silver ion (e.g., at least 3000 ppm, or 4000 ppm of silver ion). For example, in some embodiments, the antimicrobial agent contains 2000 to 8000 ppm, or 2000 to 6000 ppm, or 2000 to 5000 ppm, or 3000 to 8000 ppm, or 3000 to 6000 ppm, or 3000 to 5000 ppm of silver ion. The type of metal ion and/or concentration can be used to address various details of the article and/or impart particular antimicrobial properties to the article.

For example, if the article is used to impart an efficacious amount of silver ion to textiles during a laundry cycle, various factors may influence the concentration of the silver ion in the antimicrobial agent to ensure an efficacious amount is transferred to the textiles. These factors may include: (i) the size of the wash basin in the washer; (ii) the amount of water used in the wash basin during a laundry cycle; (iii) the size of the dryer; (iv) the temperature inside the dryer during a drying cycle; (v) the amount of convection inside the dryer during a drying cycle: (vi) the amount of textiles to be laundered during the laundry cycle, and/or (vii) the type of textile to be laundered during the laundry cycle, among other possibilities.

Accordingly, in various embodiments the efficacious amount of metal ion that imparts antimicrobial activity in the laundered textiles can be in the range of approximately 1.5 to approximately 15 mg of Ag⁺ per kg of laundered textiles. In some examples, the efficacious amount of metal ion (e.g., silver ion) per kg of laundered textiles can be approximately: 1 mg of Ag⁺ per kg of laundered textiles, 1.5 mg of Ag⁺ per kg of laundered textiles, 2 mg of Ag⁺ per kg of laundered textiles, 2.5 mg of Ag⁺ per kg of laundered textiles, 3 mg of Ag⁺ per kg of laundered textiles, 3.5 mg of Ag⁺ per kg of laundered textiles, 4 mg of Ag⁺ per kg of laundered textiles, 4.5 mg of Ag⁺ per kg of laundered textiles, 5 mg of Ag⁺ per kg of laundered textiles, 5.5 mg of Ag⁺ per kg of laundered textiles, 6 mg of Ag⁺ per kg of laundered textiles, 6.5 mg of Ag⁺ per kg of laundered textiles, 7 mg of Ag⁺ per kg of laundered textiles, 7.5 mg of Ag⁺ per kg of laundered textiles, 8 mg of Ag⁺ per kg of laundered textiles, 8.5 mg of Ag⁺ per kg of laundered textiles, 9 mg of Ag⁺ per kg of laundered textiles, 9.5 mg of Ag⁺ per kg of laundered textiles, 10 mg of Ag⁺ per kg of laundered textiles, 10.5 mg of Ag⁺ per kg of laundered textiles, 11 mg of Ag⁺ per kg of laundered textiles, 11.5 mg of Ag⁺ per kg of laundered textiles, 12 mg of Ag⁺ per kg of laundered textiles, 12.5 mg of Ag⁺ per kg of laundered textiles, 13 mg of Ag⁺ per kg of laundered textiles, 13.5 mg of Ag⁺ per kg of laundered textiles, 14 mg of Ag⁺ per kg of laundered textiles, 14.5 mg of Ag⁺ per kg of laundered textiles, 15 mg of Ag⁺ per kg of laundered textiles, 15.5 mg of Ag⁺ per kg of laundered textiles, 16 mg of Ag⁺ per kg of laundered textiles, 16.5 mg of Ag⁺ per kg of laundered textiles, or 17 mg of Ag⁺ per kg of laundered textiles. Similar amounts can be used for other metallic ionic compounds to provide the metal ion in an amount that provides anti-microbial efficacy to the treated textiles.

In other examples, the antimicrobial agent may be made up of or more quaternary ammonium compounds having an antimicrobial activity. These quaternary ammonium compounds may include one or more of the following: benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide. The type of quaternary ammonium compounds and/or concentration can be used to address various details of the intended use of the article.

For example, if the article is used to impart an efficacious amount of quaternary ammonium compounds to textiles during a laundry cycle, various factors may influence the concentration of the quaternary ammonium compounds in the antimicrobial agent to ensure an efficacious amount is transferred to a particular batch of textiles. These factors may include: (i) the size of the wash basin in the washer; (ii) the amount of water used in the wash basin during a laundry cycle; (iii) the size of the dryer; (iv) the temperature inside the dryer during a drying cycle; (v) the amount of convection inside the dryer during a drying cycle; (vi) the amount of textiles to be laundered during the laundry cycle; and/or (vii) the type of textile to be laundered during the laundry cycle, among other possibilities.

In another aspect, the article may include functional agents other than the anti-microbial agents described herein. For example, the article may include detergents, bleaches, fabric softeners, or fragrances. In some embodiments, the article includes at least one of anionic surfactants, non-ionic surfactants, cationic surfactants, bleach, or odorants. Such surfactants may include stearic acid (octadecanoic acid), which may be used on the nonwoven multicomponent sheet for a number of purposes (e.g., softening purposes). If such surfactants are used in conjunction with the antimicrobial agents (e.g., Ag⁺), then additional chemical structures (e.g., silver stearate) may be formed on the multicomponent sheet/article, and/or the treated textiles, among other possibilities. These functional agents may be incorporated into the article in a number of ways, including sprayed onto the article and/or used a solution (or part of a solution) in which the article is dipped. In other examples, these detergents, bleaches, fabric softeners, or fragrances anionic surfactants, non-ionic surfactants, cationic surfactants, or odorants, may make up a portion or layer of the article itself, any of which may dissolve during one or more phases of a laundry cycle (e.g., in a wash, rinse, and/or drying cycle).

For example, the article may be sprayed with a solution of the functional agent or dipped in a solution of the functional agent. A solution of the functional agent may also be rolled onto the article. After applying the functional agent to the article, the article may be dried and/or otherwise cured before use in a particular environment.

In another aspect, the article can be made up of one or more portions, any of which may include one or more antimicrobial or functional agents. For example, the article may include a first portion made up of one or more antimicrobial agents and a second portion made up of one or more functional agents. In another aspect, the article can include one or more layers of one or more antimicrobial and functional agents. For example, the article can include a first layer of an antimicrobial agent and a second layer of a functional agent. In other example, the article can include a first layer of an antimicrobial agent, a second layer of a functional agent, and a third layer of an antimicrobial agent. In other example, the article can include a first layer of a functional agent, a second layer of an antimicrobial agent, and a third layer of a functional agent. The first layer, second layer, and third layer can be independently selected from any of the antimicrobial and functional agents as described herein. In some embodiments, the first layer, second layer, and third layer are all different. In other embodiments, the first layer and the third layer are different from the second layer. In some embodiments the first layer and the third layer are the same and the second layer is different from the first and third layer.

In a further aspect, either or both of the metal ion or quaternary ammonium compound may be transferred to the textiles during one or more parts of a laundry cycle. As used herein, a laundry cycle may include one or more of a wash cycle, rinse cycle, or dry cycle, executed in a wash basin, washing machine (commercial or residential), and/or dryer (commercial or residential), among other possibilities.

In some examples, the laundry cycle can include a wash cycle and/or rinse cycle and the efficacious amount of the metal ion or quaternary ammonium compound may transfer to the textile based on exposure to water during the wash cycle and/or rinse cycle. The transfer mechanism is not particularly limited. For example, the metal ion and/or quaternary ammonium compound may be transferred by any known mechanical or physiochemical (e.g., adsorption, absorption, ion exchange, vapor deposition) process. In other examples, the laundry cycle may include a dry cycle and the efficacious amount of at least one of the metal ion or quaternary ammonium compound may transfer to the textile based on exposure to water (e.g., from wet textiles loaded in the dryer with the article), heat, and/or air during the dry cycle. The source of water during the drying cycle is not particularly limited and can be either solid (i.e. ice) or liquid form.

In an embodiment, a method for producing an article as described herein may include providing a nonwoven multicomponent sheet, wherein the nonwoven multicomponent sheet comprises at least two materials. In a further aspect, this method includes applying an antimicrobial agent as described herein to the nonwoven multicomponent sheet as described herein. For example, the method comprises applying an antimicrobial agent comprising at least one of a metal ion or quaternary ammonium compound having antimicrobial activity to the nonwoven multicomponent sheet, wherein an efficacious amount of at least one of the metal ion or quaternary ammonium compound transfers to the textile during a laundry cycle. For example, applying can include spraying a solution of the antimicrobial agent onto the nonwoven multicomponent sheet, dipping the nonwoven multicomponent sheet into a solution of the antimicrobial agent, or rolling a solution of the antimicrobial agent onto the multicomponent sheet. In some embodiments, the method of producing an article further includes drying the article. In some embodiments, the method of producing an article further includes folding the article.

In a further aspect, these methods for producing the article may be done manually (e.g., by hand dipping the nonwoven multicomponent sheet into a container of solution of the antimicrobial agent), among other possibilities. For example, in some embodiments, the article may be produced as part of an automated application system, in which the article is treated with the antimicrobial agent using a mechanical portion (e.g., a conveyor belt, robotic arm, etc.) to dip the nonwoven multicomponent sheet into a container of the antimicrobial agent and then transfer the treated article to another area to dry and/or otherwise cure. In a further aspect, in some examples, may detect and/or other adjust one or more components of the automated application system in producing the article. For example, the automated application system may monitor the concentration of the antimicrobial agent in the container of and adjust the concentration as needed to ensure consistent concentrations on the treated nonwoven multicomponent sheet, among other parameters (e.g., length of time the sheet is dipped in the container of solution of the antimicrobial agent). In other examples, the article may be produced as part of an automated application system, in which the article is treated with the antimicrobial agent using a mechanical portion to otherwise apply the antimicrobial agent to the nonwoven multicomponent sheet (e.g., a spray nozzle, roller, etc.) and then transfer the treated article to another area to dry and/or otherwise cure. Other examples are possible.

For example, in an embodiment, a method for treating one or more textiles may include loading one or more textiles and the article of the disclosure into a container containing water (e.g., the water basin of a residential washing machine during a wash cycle). The method may also include exposing the one or more textiles and the article in the water during the wash cycle and/or rinse cycles. During the wash cycle and/or rinse cycles, the article may release the metal ion or quaternary ammonium compound (e.g., based on exposure to water during one or more of these cycles). Once released from the article, the metal ion and/or quaternary ammonium compound may attach to the one or more textiles. After the wash cycle and/or rinse cycles, the article may be removed along with the wet textiles and moved to the dryer. For example, the method may also include transferring the textile and the article to a dryer and conducting a dry cycle. In another example, the method may also include transferring the textile and the article to a dryer and conducting a steam cycle. After the wash cycle and/or rinse cycles, the article may be reused by re-applying the antimicrobial agent to the article. For example, the used article may be sprayed with a solution of the antimicrobial agent or dipped in a solution of the antimicrobial agent. The article can also be configured for single-use, whereby it is meant to be discarded following one laundry process application. In other examples, a solution of the antimicrobial agent may be rolled onto the used article. The article may then be used in the method for treating one or more textiles as described herein.

In an embodiment, a method for treating one or more textiles may include loading one or more textiles and the article of the disclosure into a dryer. This method may also include exposing the one or more textiles to the article during at least one of a dry cycle or steam cycle. During the dry cycle and/or steam cycle, the article may release the metal ion and/or quaternary ammonium compound (e.g., based on exposure to water remaining on the one or more textiles from the wash and/or dry cycles), heat, and/or air (e.g., convection), among other possibilities. For example, after the dry cycle, the article may be reused by re-applying the antimicrobial agent to the article. For example, the used article may be sprayed with a solution of the antimicrobial agent or dipped in a solution of the antimicrobial agent. The article can also be configured for single-use, whereby it is meant to be discarded following one laundry process application. In other examples, a solution of the antimicrobial agent may be rolled onto the used article. The article may then be used in the method for treating one or more textiles as described herein.

In some embodiments, a method may include loading the one or more textiles and the article of the disclosure into a container containing water and exposing the one or more textiles to the article during the wash cycle and/or rinse cycles. In a further aspect, this method may include, after the wash cycle and/or rinse cycles, the article may be removed along with the wet textiles and moved to the dryer and also exposing the one or more textiles to the article during a dry cycle, among other possibilities.

### EXAMPLES

To illustrate the example embodiments described above, several candidate sheets were prepared and tested to measure the efficacy of the transfer of silver ion from candidate sheets to textiles during one or more laundry cycles. Further details are provided below.

### Example 1: Initial Candidate Sheets Evaluation

Before use in a laundry cycle, each of these candidate sheets was treated with a solution containing antimicrobial agents containing silver ion. After treatment, each of these candidate sheets was allowed to dry in specific conditions. After drying, the amount of silver ion transferred to each of the candidate sheets was measured.

Article Preparation and Silver Ion Uptake (Phase I)

Six candidate sheets were evaluated: (1) 100% bi-component material comprising approximately: 49.65% high-density polyethylene, 49.65% poly(ethylene terephthalate), 0.3% titanium dioxide, and 0.4% finish oil (referred to hereafter as “100% BICO”); (2) 70% rayon/30% polyester material (referred to hereafter as “70/30% RAY-POLY”): (3) 100% rayon material (referred to hereafter as “100% RAY”); (4) 100% cotton material (referred to hereafter as “100% COTTON”); (5) 100% polyester material of a first set of dimensions (referred to hereafter as “100% POLY I”); and (5) 100% polyester material of a second set of dimensions (referred to hereafter as “100% POLY II”).

Each of the candidate sheets was cut into specific dimensions and each had an associated mass after cutting, but before treatment with the antimicrobial agent. For each candidate sheet, two samples of each candidate sheet were created, for a total of twelve samples. Table 1 shows the comparisons of the approximate masses and dimensions of each candidate sheet after cutting, but before treatment with the antimicrobial agent.

TABLE 1

| | | | | | Thick- | Volume |
|---|---|---|---|---|---|---|
| | Mass | Length | Width | Area | ness | (cubic |
| Candidate Sheet | (g) | (in) | (in) | (sq. in) | (in) | in) |
| 100% BICO | 2.470 | 9.625 | 3.875 | 37.297 | 0.052 | 1.922 |
| 70/30% RAY- | 2.165 | 9.875 | 4.250 | 41.969 | 0.008 | 0.336 |
| POLY | | | | | | |
| 100% RAY | 1.095 | 10.750 | 4.375 | 47.031 | 0.005 | 0.230 |
| 100% COTTON | 3.590 | 10.125 | 4.125 | 41.766 | 0.022 | 0.936 |
| 100% POLY I | 2.180 | 10.375 | 4.125 | 42.797 | 0.040 | 1.695 |
| 100% POLY II | 1.480 | 8.250 | 4.250 | 35.063 | 0.034 | 1.185 |

Once each of sample of the candidate sheets was cut into the dimensions summarized in Table 1, a solution was prepared containing the silver ion. Specifically, in Example 1, 1.6 milliliters (“ml”) of SilvaClean® solution was diluted into 8.4 ml of purified water for a total of 10 ml of solution (“SilvaClean®+water solution”). The mixture was then shaken to ensure that the SilvaClean® solution was sufficiently incorporated into the purified water in the SilvaClean®+water solution. Based on the silver ion concentration of the SilvaClean® solution, the 10 ml of SilvaClean®+water solution contained 495.2 mg of Ag⁺.

The SilvaClean®+water solution was then divided into ten separate 1 ml portions, each of which was further diluted in 15 ml of purified water, for a total volume of 16 ml, each, and mixed. Each of those 16 ml portions was then then further diluted with an additional 500 ml of purified water and mixed to produce ten 0.516 liter (“L”) treatment solutions (“treatment solution”), each with a silver ion concentration of 95.969 ppm (49.52 mg/0.516 L=95.969 ppm). Two additional 0.516 L treatment solutions were prepare in this same manner, for a total of twelve treatment solutions, one for each sample of the candidate sheets.

Each treatment solution was then transferred into a container and each of the samples of the candidate sheets was placed into the treatment solution and gently agitated inside the container and treatment solution for 1 minute. Each of the samples of the candidate sheets was then turned over to the opposing side and gently agitated inside the container and treatment solution for an additional 1 minute.

During this treatment process (approximately 2 minutes, total), it was observed that: (1) the 100% RAY material stuck to itself when during agitation inside the container and treatment solution and was difficult to work with; (2) the 100% COTTON material was fragile to work with and difficult to work with when wet; and (3) the 100% POLY I and 100% POLY II were easy to work with.

After each sample of the candidate sheets was treated with the treatment solution, each sample was allowed to dry in low-light condition. Specifically, each sample was allowed to dry inside of a closed box with no UV exposure. Additionally, inside of the closed box, each material was exposed to small fan to encourage convection and drying. During this drying process, it was observed that: (1) the 100% BICO material dried quickly.

After drying, one sample of each candidate sheet was analyzed for silver ion concentration uptake. Specifically, each candidate sheet was cut into several smaller pieces, three which were chosen at random, and analyzed. Upon testing, the actual uptake was lower than the expected uptake for each candidate sheet. It was observed that of the candidate sheets, 100% POLY I and 100% POLY II had the lowest uptake, while 70/30% RAY-POLY had the highest uptake.

Transfer of Silver Ion from Candidate Sheets to Textiles (Phase II)

After each of these was treated with silver ion, the remaining sample of each of the candidate sheets was placed in a dryer with wet textiles and allowed to dry during a drying cycle with the textiles. The amount of ionic silver transferred to the textiles by each of the candidate sheets was then measured.

Specifically, for each of the treated samples of candidate sheets summarized in Table 1 except 100% BICO, approximately 2.5 kg of cotton and polyester blend textiles were cut into varying size (e.g., different lengths, widths) pieces. For 100% BICO, the same procedure was followed, except for an approximately 5 kg portion of textiles. Each of the textile portions was then washed in a washing machine during a rinse cycle with no detergent to dampen the textiles.

Each portion of textiles was placed in a dryer with its respective sample of the candidate sheets and dried on a medium heat setting until all pieces of each portion of textiles were dry. This process was repeated for each of the samples of candidate sheets.

After drying, each sample of each candidate sheet was analyzed for silver ion transfer from the treated sample to its respective portion of textiles. The concentration of Ag⁺ was measured for each sample both before and after drying with each sample's respective portions of the textiles. It was observed that of the candidate sheets, 100% BICO and 100% RAY had the highest transfer percent of Ag⁺ after drying with the textiles. It was also observed that for 100% POLY I, the concentration of Ag⁺ was much higher after drying with the textiles, than before, which may be attributable to testing a non-homogenized distribution of silver on the sample before, after, or before and after drying.

It was observed that of the candidate sheets, 100% BICO and 100% RAY had the highest concentrations of Ag⁺ after drying with the textiles.

### Example 2: Focused Candidate Sheets Evaluation

In a second example, four candidate sheets were treated with a solution containing antimicrobial agents containing an increased amount of silver ion. After treatment, each of these candidate sheets was allowed to dry in specific conditions. After drying, the amount of ionic silver transferred to each of the candidate sheets was measured.

Article Preparation and Silver Ion Uptake (Phase I)

In Example 2, three candidate sheets were evaluated: (1) 100% bi-component material comprising approximately: 49.65% high-density polyethylene, 49.65% poly(ethylene terephthalate), 0.3% titanium dioxide, and 0.4% finish oil (referred to hereafter as “100% BICO”); (2) 100% rayon material (referred to hereafter as “100% RAY”); and (3) 70% rayon/30% polyester material (referred to hereafter as “70/30% RAY-POLY”).

Each of the candidate sheets was cut into specific dimensions and each had an associated mass after cutting, but before treatment with the antimicrobial agent. For each candidate sheet, two samples were created, for a total of six samples. Table 2 shows the comparisons of the masses and dimensions of each sample of candidate sheet after cutting, but before treatment with the antimicrobial agent. Each of these samples of the candidate sheets are referred to hereafter as: 100% BICO(a), 100% BICO(b), 100% RAY(a), 100% RAY(b), 70/30% RAY-POLY I(a), and 70/30% RAY-POLY I(b).

TABLE 2

| | | | | | Thick- | Volume |
|---|---|---|---|---|---|---|
| | Mass | Length | Width | Area | ness | (cubic |
| Candidate Sheet | (g) | (in) | (in) | (sq. in) | (in) | in) |
| 100% BICO(a) | 1.240 | 7.875 | 5.000 | 39.375 | 0.052 | 2.048 |
| 100% BICO(b) | 1.150 | 7.750 | 4.875 | 37.781 | 0.052 | 1.965 |
| 100% RAY(a) | 0.620 | 11.000 | 4.250 | 46.750 | 0.005 | 0.229 |
| 100% RAY(b) | 0.520 | 10.750 | 4.250 | 45.688 | 0.005 | 0.224 |
| 70/30% RAY- | 1.060 | 9.875 | 4.250 | 41.969 | 0.008 | 0.336 |
| POLY I(a) | | | | | | |
| 70/30% RAY- | 1.020 | 9.875 | 4.125 | 40.734 | 0.008 | 0.326 |
| POLY I(b) | | | | | | |

Once each of candidate sheets was cut into the dimensions summarized in Table 2, a solution was prepared containing the silver ion. Specifically, in Example 2, 2.56 ml of SilvaClean® solution was diluted into 8.4 ml of purified water for a total of 10 ml of solution. The mixture was then shaken to ensure that the SilvaClean® solution was sufficiently incorporated into the purified water in the SilvaClean® water solution. Based on the silver ion concentration of the SilvaClean® solution, the 10 ml of SilvaClean®+water solution contained 792.32 mg of silver ion.

The SilvaClean®+water solution was then divided into four separate 2.5 ml portions, each of which was further diluted in 15 ml of purified water, for a total volume of 17.5 ml, each, and mixed. Each of those 17.5 ml portions was then then further diluted with an additional 500 ml of purified water and mixed to produce four 0.5175 L treatment solutions, each with a silver ion concentration of 382.763 ppm (198.08 mg/0.5175 L=382.763 ppm). Two additional 0.5175 L treatment solutions were prepare in this same manner, for a total of six treatment solutions, one for each sample of the candidate sheets.

Each treatment solution was then transferred into a container and each of the samples of the candidate sheets was placed into the treatment solution and gently agitated inside the container and treatment solution for 2.5 minutes. Each of the samples of the candidate sheets was then turned over to the opposing side and gently agitated inside the container and treatment solution for an additional 2.5 minutes.

During this treatment process (approximately 5 minutes, total), it was observed that: (1) the 100% RAY material stuck to itself when during agitation inside the container and treatment solution and was difficult to work with.

After each sample of the candidate sheets was treated with the treatment solution, each sample was allowed to dry in low-light condition. Specifically, each sample was allowed to dry inside of a closed box with no UV exposure. Additionally, inside of the closed box, each material was exposed to small fan to encourage convection and drying. During this drying process, it was observed that: (1) the 100% BICO material dried quickly; and (2) 100% RAY material developed black spots.

After drying, each candidate sheet was analyzed for silver ion concentration uptake. Specifically, each candidate sheet was cut into several smaller pieces, three which were chosen at random, and analyzed. Upon testing, the actual uptake was lower than the expected uptake for each candidate sheet. It was observed that of the candidate sheets, 100% RAY and 70/30% RAY-POLY I had the lowest uptake, while 70/30% RAY-POLY II had the highest uptake.

Transfer of Silver Ion from Candidate Sheets to Textiles (Phase II)

After each of these candidate sheets was treated with silver ion, each of the three candidate sheets (100% BICO(a), 100% RAY(a), and 70/30% RAY-POLY I(a)) was placed in a dryer with wet textiles and allowed to dry during a drying cycle with the textiles. The amount of ionic silver transferred to the textiles by each of the candidate sheets was then measured.

Specifically, for each of the treated samples of candidate sheets, approximately 2 kg of cotton and polyester blend textiles was cut into varying size (e.g., different lengths, widths) pieces. Each of the textile portions was then washed in a washing machine during a rinse cycle with no detergent to dampen the textiles.

Each portion of textiles was placed in a dryer with its respective sample of the candidate sheets and dried on a medium heat setting until all pieces of each portion of textiles were dry. This process was repeated for each of the samples of candidate sheets. After drying, each sample of each candidate sheet was analyzed for silver ion transfer from the treated sample to its respective portion of textiles. The concentration of Ag⁺ on the treated textiles was measured for each sample after drying with each sample's respective portions of the textiles. It was observed that of the candidate sheets, 100% BICO had the highest concentrations of Ag⁺ after drying with the textiles.

### Example 3: BICO Sheets Evaluation (I)

In a third example, three candidate sheets were treated with a solution containing antimicrobial agents containing the same amount of silver ion in Example 2. After treatment, each of these candidate sheets was allowed to dry in specific conditions. After drying, the amount of ionic silver transferred to each of the candidate sheets was measured.

Article Preparation and Silver Ion Uptake (Phase I)

In Example 3, three candidate sheets were evaluated: (1) 100% bi-component material of a first set of dimensions comprising approximately: 49.65% high-density polyethylene, 49.65% poly(ethylene terephthalate, 0.3% titanium dioxide, and 0.4% finish oil (referred to hereafter as “100% BICO I”); (2) 100% bi-component material of a second set of dimensions comprising approximately: 49.65% high-density polyethylene, 49.65% poly(ethylene terephthalate, 0.3% titanium dioxide, and 0.4% finish oil (referred to hereafter as “100% BICO 11”); and (3) 100% bi-component material of a third set of dimensions comprising approximately: 49.65% high-density polyethylene, 49.65% poly(ethylene terephthalate, 0.3% titanium dioxide, and 0.4% finish oil (referred to hereafter as “100% BICO III”).

Each of the candidate sheets was cut into specific dimensions and each had an associated mass after cutting, but before treatment with the antimicrobial agent. For each candidate sheet, two samples of each candidate sheet were created, for a total of six samples. Table 3 shows the comparisons of the masses and dimensions of each sample of candidate sheet after cutting, but before treatment with the antimicrobial agent. Each of these samples of the candidate sheets are referred to hereafter as: 100% BICO I(a), 100% BICO I(b), 100% BICO II(a), 100% BICO II(b), 100% BICO III(a), and 100% BICO III(b).

TABLE 3

| | | | | | Thick- | Volume |
|---|---|---|---|---|---|---|
| | Mass | Length | Width | Area | ness | (cubic |
| Candidate Sheet | (g) | (in) | (in) | (sq. in) | (in) | in) |
| 100% BICO I(a) | 0.960 | 8.000 | 4.000 | 32.000 | 0.520 | 16.640 |
| 100% BICO I(b) | 1.050 | 8.000 | 4.000 | 32.000 | 0.520 | 16.640 |
| 100% BICO II(a) | 0.910 | 7.750 | 4.000 | 31.000 | 0.520 | 16.120 |
| 100% BICO II(b) | 0.970 | 8.000 | 4.000 | 32.000 | 0.520 | 16.640 |
| 100% BICO III(a) | 1.920 | 8.000 | 8.250 | 66.000 | 0.520 | 34.320 |
| 100% BICO | 2.080 | 8.000 | 8.250 | 66.000 | 0.520 | 34.320 |
| III(b) | | | | | | |

Once each of candidate sheets was cut into the dimensions summarized in Table 3, a solution was prepared containing the silver ion. Specifically, in Example 3, 2.56 ml of SilvaClean® solution was diluted into 8.4 ml of purified water for a total of 10 ml of solution. The mixture was then shaken to ensure that the SilvaClean®, solution was sufficiently incorporated into the purified water in the SilvaClean®+water solution. Based on the silver ion concentration of the SilvaClean® solution, the 10 ml of SilvaClean®+water solution contained 792.32 mg of silver ion.

The SilvaClean®+water solution was then divided into four separate 2.5 ml portions, each of which was further diluted in 15 ml of purified water, for a total volume of 17.5 ml, each, and mixed. Each of those 17.5 ml portions was then then further diluted with an additional 500 ml of purified water and mixed to produce four 0.5175 L treatment solutions, each with a silver ion concentration of 382.763 ppm (198.08 mg/0.5175 L=382.763 ppm). Two additional 0.5175 L treatment solutions were prepare in this same manner, for a total of six treatment solutions, one for each sample of the candidate sheets.

Each treatment solution was then transferred into a container and each of the samples of the candidate sheets was placed into the treatment solution and gently agitated inside the container and treatment solution for 2.5 minutes. Each of the samples of the candidate sheets was then turned over to the opposing side and gently agitated inside the container and treatment solution for an additional 2.5 minutes.

After each sample of the candidate sheets was treated with the treatment solution, each sample was allowed to dry in low-light condition. Specifically, each sample was allowed to dry inside of a closed box with no UV exposure. Additionally, inside of the closed box, each material was exposed to small fan to encourage convection and drying.

After drying, each candidate sheet was analyzed for silver ion concentration uptake. Specifically, each candidate sheet was cut into several smaller pieces, three which were chosen at random, and analyzed. Upon testing, the actual uptake was lower than the expected uptake for each candidate sheet.

Transfer of Silver Ion from BICO Sheets to Textiles (Phase II)

After drying, two of the candidate sheets (100% BICO I(a) and 100% BICO I(b)), were each placed in a dryer with approximately 2 kg of cotton and polyester blend textiles cut into varying size (e.g., different lengths, widths) pieces and allowed to dry during a drying cycle with the textiles. Before drying, these textiles were washed in a washing machine during a rinse cycle with no detergent to dampen the textiles. During drying, these two candidate sheets and their respective textiles were dried on a medium heat setting until all pieces of each portion of textiles were dry.

For the other four candidate sheets (100% BICO II(a), 100% BICO II(b), 100% BICO III(a), and 100% BICO III(b)), each was placed in a washer and allowed to go through a wash cycle and rinse cycle with approximately 2 kg of cotton and polyester blend textiles cut into varying size (e.g., different lengths, widths) and no detergent. After wash and rinse cycles, these four candidate sheets were each placed in a dryer with their respective wet textiles and allowed to dry during a drying cycle with the textiles. During drying, these four candidate sheets and their respective textiles were dried on a medium heat setting until all pieces of each portion of textiles were dry.

After drying, each sample of each candidate sheet was analyzed for silver ion transfer from the treated sample to its respective portion of textiles. Specifically, each portion of textiles was cut into several smaller pieces, three which were chosen at random, and analyzed. The concentration of Ag⁺ on the treated textiles was measured for each sample after drying with each sample's respective portions of the textiles.

It was observed that of the candidate sheets, 100% BICO I(a) and 100% BICO I(b) had the highest concentrations of Ag⁺ after drying with the textiles and 100% BICO 11(a) and 100% BICO II(b) had the highest concentrations of Ag⁺ after washing with the textiles. It was also observed that of the candidate sheets, 100% BICO I(a) and 100% BICO I(b) folded over and stuck to themselves during drying and 100% BICO III(a) and 100% BICO III(b) had the longest drying time. It was also observed that for each candidate sheet, the concentration of Ag⁺ was much higher on the treated textiles than was expected at 100% transfer from the candidate sheet after drying with the textiles. This result may be attributable to attributable to testing a non-homogenized distribution of silver on the candidate before, after, or before and after drying, as well as potential interference from one or more components of the candidate sheets with the testing equipment.

### Example 4: BICO Sheets Evaluation (II)

In a fourth example, two candidate sheets were treated with a solution containing antimicrobial agents containing increased amount of silver ion. After treatment, each of these candidate sheets was allowed to dry in specific conditions. After drying, the amount of ionic silver transferred to each of the candidate sheets was measured.

Article Preparation and Silver Ion Uptake (Phase I)

Two candidate sheets were evaluated, both of which are 100% bi-component materials comprising approximately 50 wt. % high-density polyethylene and approximately 50 wt. % polypropylene (hereinafter referred to hereafter as “100% BICO IV” and “100% BICO V”).

Each of the candidate sheets was cut into specific dimensions (8.5×12.5 inches or ″) before treatment with the antimicrobial agent. Each of the candidate sheets were tri-folded to a final dimension of 8.5×4.16″. Table 4 shows the comparisons of the approximate dimensions of each candidate sheet after cutting, but before treatment with the antimicrobial agent.

TABLE 4

| Candidate | Length | Width | Area | Thickness | Volume |
|---|---|---|---|---|---|
| Sheet | (in) | (in) | (sq. in) | (in) | (cubic in) |
| 100% BICO IV | 12.5 | 8.5 | 106.25 | 0.015 | 1.59 |
| 100% BICO V | 12.5 | 8.5 | 106.25 | 0.015 | 1.59 |

For treating the candidate sheets with the antimicrobial agent, a solution was prepared containing the silver ion. Specifically, in Example 4, each of the candidate sheets had a mass of 110 grams and 357.5 ml of SilvaClean® solution was diluted into 55 L of purified water for a total of 55.3575 L of solution. The mixture was then shaken to ensure that the SilvaClean® solution was sufficiently incorporated into the purified water in the SilvaClean®+water solution. Based on the silver ion concentration of the SilvaClean® solution, the SilvaClean®+water solution contained 4367 ppm of silver ion.

Each treatment solution was then transferred into a container and each of the samples were placed into the treatment solution and gently agitated inside the container and treatment solution for 2.5 minutes. Each of the candidate sheets was then turned over to the opposing side and gently agitated inside the container and treatment solution for an additional 2.5 minutes.

After each of the candidate sheets was treated with the treatment solution, each sheet was allowed to dry in low-light condition. Specifically, each sheet was allowed to dry inside of a closed box with no UV exposure. Additionally, inside of the closed box, each material was exposed to small fan to encourage convection and drying.

After drying, each sample was analyzed for silver ion amount uptake. Specifically, each of the candidate sheets was cut into several smaller pieces, two of which were chosen at random, and analyzed. Table 5 shows the comparisons of the average silver ion uptake for each candidate sheet (averaged over the results for the two smaller pieces of each candidate sheet) after treatment with the antimicrobial agent and drying.

TABLE 5

| Candidate | Expected Ag⁺ Per | Actual Ag⁺ Per | Percent |
|---|---|---|---|
| Sheet | Sheet (ppm) | Sample (ppm) | Uptake (%) |
| 100% BICO IV | 4367.0 | 3400 | 78% |
| 100% BICO V | 4367.0 | 3800 | 87% |

As Table 5 shows, each of the samples of candidate sheets were expected to uptake 17.46 mg of Ag⁺. Upon testing, the actual uptake was high for each sample tested.

Transfer of Silver Ion from BICO Sheets to Textiles (Phase II)

Four samples of the candidate sheet 100% BICO IV and four samples of the candidate sheet 100% BICO V were evaluated for their silver ion transfer with different textiles.

Each of the eight samples were placed in a washer and allowed to go through a wash cycle (with detergent) and a rinse cycle, both with approximately 2.5 kg of textiles. Four different textile conditions were tested: (a) sized cotton/polyester blend, (b) cotton/polyester blend, (c) sized 100% cotton, and (d) 100% cotton. For the sized conditions, the textiles were treated with a sizing agent prior to use. After wash and rinse cycles, the eight samples were each placed in a dryer with their respective wet textiles and allowed to dry during a drying cycle with the textiles. During drying, these eight samples and their respective textiles were dried on a medium heat setting until all pieces of each portion of textiles were dry.

After drying, each sample of each candidate sheet was analyzed for silver ion transfer from the treated sample to its respective portion of textiles. Specifically, each portion of textiles was cut into several smaller pieces, three which were chosen at random, and analyzed.

Table 6 shows the comparisons of the average actual concentration of Ag⁺ on the treated textiles measured for each sample (averaged over the results for the three smaller pieces of each portion of textiles) after drying with each sample's respective textile load, as well as the expected concentration on the treated textiles as well.

TABLE 6

| | | Expected Ag⁺on | Measured Ag⁺ | |
|---|---|---|---|---|
| Candidate | | Textiles at 100% | on Textiles After | Transfer |
| Sheet | Textile Type | Transfer (mg/kg) | Dryer (mg/kg) | % |
| 100% BICO IV(a) | Sized Cotton/Poly Blend | 6.99 | 2.7 | 39% |
| 100% BICO IV(b) | Cotton/Poly Blend | 6.99 | 1.825 | 26% |
| 100% BICO IV(c) | Sized 100% Cotton | 6.99 | 7.725 | 111% |
| 100% BICO IV(d) | 100% Cotton | 6.99 | 3.525 | 50% |
| 100% BICO V(a) | Sized Cotton/Poly Blend | 6.99 | 2.775 | 40% |
| 100% BICO V(b) | Cotton/PolyBlend | 6.99 | 1.25 | 18% |
| 100% BICO V(c) | Sized 100% Cotton | 6.99 | 2.65 | 38% |
| 100% BICO V(d) | 100% Cotton | 6.99 | 1.475 | 21% |

For all types of textiles tests, high transfer percentages were observed, which resulted in a sufficient amount of Ag⁺ on the treated textiles to impart efficacious antimicrobial properties to the textiles.

Transfer of Silver Ion from BICO Sheets to Textiles in Dryer (Phase III)

A sample of the 100% BICO IV sheet was also evaluated for silver ion transfer in the dryer on dry textiles using a moisture delivery mechanism in the dryer.

In this phase of the experiment, the 100% BICO IV sample was placed in a dryer with an ice cube and approximately 2.5 kg of cotton and polyester blend textiles cut into varying size (e.g., different lengths, widths) pieces. Adding the ice cube simulates a steam cycle as is common in modern dryers. A dryer cycle was then initiated and the 100% BICO IV sample and the ice cube were allowed to dry during a drying cycle with the textiles. During drying, the sample and the respective textiles were dried on a medium heat setting until all pieces of each portion of textiles were dry.

Table 7 shows the comparisons of the average actual concentration of Ag⁺ on the treated textiles measured for the sample (averaged over the results for the three smaller pieces of each portion of textiles) after drying with the sample's respective textile load, as well as the expected concentration on the treated textiles.

TABLE 7

| | Expected Ag⁺ on | Measured Ag⁺ on | |
|---|---|---|---|
| Candidate | Textiles at 100% | Textiles After | |
| Sheet | Transfer (mg/kg) | Dryer (mg/kg) | Transfer % |
| 100% BICO IV | 6.95 | 2.33 | 34% |

Thus, high transfer percentages were observed, which resulted in a sufficient concentration of Ag⁺ on the treated textiles to impart efficacious antimicrobial properties to the textiles in the dryer alone.

1. An article for treating a textile with an antimicrobial agent, wherein the article comprises:
(a) a nonwoven multicomponent sheet, wherein the nonwoven multicomponent sheet comprises at least two materials; and
(b) an antimicrobial agent comprising at least one of a metal ion and quaternary ammonium compound having antimicrobial activity.

2. The article of claim 1, wherein the antimicrobial agent comprises at least 3000 to 5000 ppm of a silver ion.

3. The article of claim 1, wherein the nonwoven multicomponent sheet has a surface area in the range of 60-150 in² and a thickness in the range of approximately 0.1 to 0.25 inches.

4. The article of claim 1, wherein the article is configured to transfer the efficacious amount at least one of the metal ion and quaternary ammonium compound to the textile during a laundry cycle in an efficacious amount to reduce, eliminate or prevent microbial contamination of the textile.

5. The article of claim 1, wherein the at least two materials comprise two of the following: polyethylene, polypropylene, or polyethylene terephthalate.

6. (canceled)

7. The article of claim 1, wherein the nonwoven multicomponent sheet comprises at least 30% high-density polyethylene and at least 30% polyethylene terephthalate.

8. (canceled)

9. The article of claim 1, wherein the nonwoven multicomponent sheet comprises at least 30% high-density polyethylene and at least 30% polypropylene.

10. (canceled)

11. The article of claim 1, wherein the at least two materials comprise rayon.

12. The article of claim 1, wherein the at least two materials comprise rayon and polyester.

13. (canceled)

14. The article of claim 1, wherein the at least two materials comprise at least two of polyethylene, polypropylene, and polyurethane.

15. (canceled)

16. (canceled)

17. (canceled)

18. The article of claim 4, wherein the laundry cycle comprises a wash cycle, a rinse cycle, and a dry cycle and wherein the efficacious amount of at least one of the metal ion or quaternary ammonium compound transfers to the textile based on exposure to water during the wash cycle, or on exposure to water during the rinse cycle, or on exposure to water during the dry cycle, or on exposure to air and/or heat during the dry cycle, or on exposure to heat during the dry cycle.

19. (canceled)

20. (canceled)

21. (canceled)

22. (canceled)

23. The article of claim 1, wherein the nonwoven multicomponent sheet comprises a first portion and a second portion, wherein the first portion comprises the at least two materials, and wherein the second portion comprises an additional material.

24. The article of claim 1, wherein the article further comprises a fragrance and/or a surfactant.

25. (canceled)

26. (canceled)

27. A method of producing an article of claim 1, comprising:
applying the antimicrobial agent to the nonwoven multicomponent sheet.

28. (canceled)

29. (canceled)

30. (canceled)

31. The method of claim 27, further comprising drying the article.

32. The method of claim 27, further comprising folding the article.

33. The method of claim 27, wherein the antimicrobial agent is applied to the nonwoven multicomponent sheet and allowed to dry in a low-light condition.

34. A method for treating a textile comprising:
loading the textile and the article of claim 1 into a container containing water; and
exposing the textile and the article in the water during a laundry cycle comprising at least one of a wash cycle and a rinse cycle.

35. (canceled)

36. (canceled)

37. A method for treating a textile comprising:
loading the textile and the article of claim 1 into a dryer; and
exposing the textile to the article during the laundry cycle comprising at least one of a dry cycle and a steam cycle.

38. An article for treating a textile with an antimicrobial agent, wherein the article comprises:
(a) a nonwoven multicomponent sheet, wherein the nonwoven multicomponent sheet comprises at least two materials, and wherein the nonwoven multicomponent sheet is approximately 90-130 square inches and approximately 0.1 to 0.25 inches thick; and
(b) an antimicrobial agent comprising at least 4000 parts per million of a silver ion having antimicrobial activity, wherein an efficacious amount of the silver ion transfers to the textile during a laundry cycle, wherein the efficacious amount is between 1.5 and 15 milligrams of silver ion per kilogram of textile.
